(19) United States
(12) Patent Application Publication
(10) Pub. No.: US 2020/0293956 A1
(43) Pub. Date: Sep. 17, 2020

(54) Vehicle Relocation System

(71) Applicant: Marcelo Ruiz, San Diego, CA (US)

(72) Inventor: Marcelo Ruiz, San Diego, CA (US)

(21) Appl. No.: 16/815,912

(22) Filed: Mar. 11, 2020

Related U.S. Application Data
(60) Provisional application No. 62/816,755, filed on Mar. 11, 2019.

(51) Int. Cl. G06Q 10/02; G06Q 50/26

(52) U.S. Cl. CPC G06Q 10/02; G01C 21/3453; G06Q 50/265

(57) ABSTRACT

A computer implemented method for relocating vehicles for requesting owners thereof is provided which assigns a first licensed driver to drive the vehicle of a user from a starting location to a destination location. Concurrently with assigning the first licensed driver, a second licensed driver having a vehicle proximate to the destination location calculated to arrive at substantially the same time as the first driver, is chosen. The second licensed driver, upon arriving at the destination location, drives the first licensed driver back to the starting location.

This application claims priority to U.S. Provisional Patent Application Ser. No. 62/816,755 filed on Mar. 11, 2018, and is incorporated herein in its entirety by this reference thereto.

### BACKGROUND OF THE INVENTION

### 1. Field of the Invention

The present invention relates generally to a vehicle relocation system. More particularly, it relates to a network and software-enabled system employing computer executable code, enabling a vehicle owner, having a vehicle in a vehicle starting location, to request and automatically have a first driver who is preferably within walking distance to arrive at the starting location of the vehicle, and subsequently drive the vehicle to the requested geographic location, whereupon the first driver will be relocated to the starting location by a second driver who is requested to meet the first driver at the requested geographic location concurrently with the request for the first driver.

### 2. Prior Art

In recent years, with the proliferation of smart phones capable of operating as miniature computers which have continuous network connections from cellular providers, owners of smart phones are able to access networks such as the internet virtually anywhere they or their vehicle travel. In such travels, smartphone owners can find themselves in possession of their vehicle but unable to drive it to a desired geographic location such as their home, business, or other venue.

An all too frequent example of such occurs when a vehicle user drives their vehicle to a venue such as a bar or restaurant for an evening meal alone or with friends. Such occasions will generally involve the vehicle owner consuming alcoholic beverages over the duration of their bar or restaurant visit.

For those vehicle owners who are prudent in their alcohol consumption and maintain their blood alcohol at a legal limit, driving their vehicle home or to the desired geographic location at the end of their meal or festivities is not a problem. However, for a large portion of vehicle owners and users who consume alcoholic beverages, their legal driving of the vehicle in which they arrived at the restaurant or bar or festivities, can be questionable at best. Many such vehicle users may know they are unable to legally drive, or on the cusp of such, and will refrain from such. Such vehicle owners, in a responsible fashion, will request a taxi or ride service or a friend to drive them home or to a destination.

However, a good portion of such incapacitated drivers, because their vehicle is located at the restaurant, bar, or venue, which is not their home or desired geographic destination, will attempt to drive their vehicle to the desired location. Such behavior, while irresponsible, has shown in the past to be behavior which is induced by the fact the vehicle driver does not wish to leave their vehicle unprotected in the locale of the restaurant or festivities. This recalcitrance to leave the vehicle may be out of a fear it will be stolen or broken into or out of a concern they will be left without their vehicle the next morning when they are no longer intoxicated or unable to drive. Either way, such concerns can easily induce poor decisions which can have devastating results for the vehicle owner and other drivers and pedestrians along the route they decide to drive to a destination.

The system herein, employing software operating on a server configured to communicate with users such as the vehicle drivers having smart phones, provides a solution for the concerns causing such drivers to make poor choices to drive their vehicles when they know they suspect they are or they may be legally intoxicated. It does so by removing the concern of such drivers of leaving their vehicles at a venue remote to their home or ultimate geographic destination for the evening.

The forgoing examples of related art and limitations related therewith are intended to be illustrative and not exclusive, and they do not imply any limitations on the software enabled system described and claimed herein. Various limitations of the related art are already known or will become apparent to those skilled in the art upon a reading and understanding of the specification below and the accompanying drawings.

An object of the present invention is to provide a system for immediate vehicle relocation, which discerns and delivers substitute assigned drivers for vehicle owners and users, where such substitute drivers will preferably be within fifteen minutes walking distance to the starting location of the vehicle and who will then drive the vehicle to the destination geographic location, optionally with the owner or user as a rider therein.

It is another object of the invention to concurrently discern the destination geographic location and provide a secondary assigned driver to provide a return ride for the first driver, back to the starting location from which the substitute driver picked up and drove the vehicle.

These and other objects features, and advantages of the present invention, as well as the advantages thereof over existing prior art, which will become apparent from the description to follow in this specification and hereinafter described in the following detailed description which fully discloses the invention, but should not be considered as placing limitations thereon.

### SUMMARY OF THE INVENTION

The present invention employs a computing device which is operatively engaged to a computer network, and which is running executable code in electronic memory configured to accomplish the steps herein. The system in all modes is tied to a vehicle at a starting location. For this vehicle, the system enables a method providing an assigned first driver for that vehicle, for requesting vehicle owners or users, who are unable to drive that vehicle due to scheduling, driver choice, or inability to legally drive.

In the system the prime task is the relocation of a vehicle which does not have a driver who is able to drive it, from a starting location, to a user-chosen destination location. The system may also include the owner or driver of the vehicle also riding therein to the destination.

Once the system is activated by the vehicle owner or driver who is preferably a registered user using a computer or smartphone, the system will choose and dispatch an assigned first driver to the starting location where the vehicle is located. The first assigned driver is preferably within walking distance so the first assigned driver need not have a vehicle. By walking distance is meant that from a real time location of a potential first assigned driver, the time to walk to the starting location is substantially fifteen minutes or less. The assigned first driver, who is pre-screened by the system operator for licensing and insurance, will on arrival at the vehicle starting location drive the vehicle of the owner, or user thereof, from the starting location to a user-chosen destination geographic location.

The system further concurrently employs computer executable code, operating to the task of ascertaining an arrival time for the vehicle and the first assigned driver at the destination geographic location. The system will thus calculate the time required for the first assigned driver and the vehicle to drive to the destination location and from a plurality of available secondary drivers who can reach the destination location in the calculated required time, the system will assign a secondary driver.

This secondary driver will be dispatched with their vehicle and directed by the system to arrive at the destination geographic location, at a time calculated to be substantially the same as the time of the arrival calculated for the first assigned driver and the vehicle. Thereafter, the first or assigned driver will be relocated back to the starting location by the secondary driver. The original user who owns or legally operates the vehicle being transported by the system is billed for both drivers by the system.

In the method and system herein, users such as vehicle owners or authorized vehicle users, such as those driving borrowed or rented vehicles, will register with the system provider herein. In a registration step, such users will provide contact information such as an address, a phone number, and an email address. During registration, users will also provide payment information for the system services such as registering a credit card, a PAYPAL account, a bank account or the like. While it is preferred such users pre-register for ease of use, such registration can be handled at the time of first use of the system and may require minimal information such as a name and means of electronic payment for the driving services requested.

The system provider, employing software having computer executable code operating to the task of confirming the registered identity of a requesting user, and a starting location of a vehicle needing a driver to the destination location, thereafter will operate to provide a first driver to drive the vehicle.

The assigned first driver is chosen from a plurality of registered drivers held in computer memory or a database thereof of drivers. The chosen first driver will be dispatched to the discerned starting location of the vehicle to drive it to a designated geographic destination location.

For security, the system employing computer executable code operating to the task, will preferably send an authentication code to both the user requesting the first driver and the first driver. In a security step, both the first driver and the requesting user will compare authentication codes to ascertain if they match, and thereby discern that the first driver was in fact assigned by the system to drive the vehicle of the requesting user.

Concurrently, in a secondary step, the system will discern which secondary drivers from a plurality of secondary drivers, held in a database thereof, is sufficiently proximate to the destination, who will then be directed to drive to the destination location. The system running computer executable code operating to the task will discern from a database held in electronic memory of secondary drivers, and their current real time locations, a secondary driver who is currently geographically positioned in real time, sufficiently proximate to the destination location, to arrive at the destination location concurrently with the first driver, or at substantially the same time as the arrival of the assigned first driver. By substantially the same time is meant between ten minutes prior to the arrival time of the assigned driver or within ten minutes after the calculated arrival time of the assigned driver for the vehicle at the destination location.

The secondary driver, upon arrival at the destination location, will then transport the first or assigned driver back to the starting location.

It should be noted that a primary factor of the computer executable code choosing the first driver is that the first driver is preferably located so proximate to the starting location, so as to be able to walk to the starting location, within a preferred time period for arrival, which is currently fifteen minutes. Thus, the first assigned driver need not own or be in a vehicle.

This deference by the system and software assigning the first driver, significantly increases the potential for the pool of registered drivers for the system to employ in such assignments. This is because it chooses assigned first drivers who can walk to the starting location as preferred, over assignable first drivers who can drive to the starting location. Since many licensed drivers do not own vehicles, it enables the system to assign first drivers from a much larger pool of drivers, who don't own, and who do own vehicles.

Additionally, the system can include first drivers who may not reside proximate to the starting point but happen to be currently located proximate to the starting point, such as licensed drivers who may be at a coffee shop, store, or other venue close to the starting location. By including licensed drivers who do not have vehicles in the pool of first assigned drivers, the system thus reduces the need for carbon emissions from vehicles, since the walking first assigned drivers need not use a vehicle which emits exhaust.

As such, the system can provide the first assigned drivers from registered drivers who are at a location proximate to the starting location, where they might walk to the starting location to provide the first driver service. Further, if the system tracks available first drivers and secondary drivers by their current location and availability, either of the first driver or secondary driver could live or be currently located proximate to the starting or destination location, or they could be driving and be located proximate thereto.

The system employing computer executable code operating to the task will calculate each respective driver's time of arrival at the starting or destination location, and assign the most appropriate first assigned and secondary assigned driver, who will arrive at the respective location in the appropriate amount of time. In all modes, the system will choose the first driver from available drivers who are currently sufficiently proximate to the starting location to walk to it over available drivers who are driving. Upon registration of drivers with the system, they will be identified as using vehicles or being pedestrians who walk to the assignment.

In this fashion, the system herein will provide users the ability to transport both their vehicle and, if needed, themselves to the desired destination location. This removes the above noted concern and recalcitrance of vehicle drivers having to leave their vehicle at a venue or starting location, and thereafter retrieve it at a later time.

In a particularly preferred mode of the system herein, the system will provide venue owners such as bars or restaurants or the like, access to the system to order services for registered and unregistered users having vehicles and themselves in need of transport from the starting location at or proximate to the venue, to the destination location desired by the vehicle owner or authorized user. Such a step will allow the venue operator to request the vehicle relocation service for vehicle owners and authorized users who the venue operator deems in need of such and either pay for the service through the venue operator account or by inputting the vehicle owner information to the system.

First assigned and secondary assigned drivers for the system herein may be preregistered and then provided operating software for their driver smart phones, running computer executable code thereon which will track their respective current location and their respective availability for driving. The software running to perform this operation on the smartphone, which will discern from onboard GPS or Map Applications, a current geographic location for the registered driver and continuously communicate the location and availability related to each respective driver to the system provider.

The system will employ computer executable code running in computer memory of a network engaged computer or server to continuously ascertain if the drivers who are pedestrians are located proximate to an assignment for driving, or, if not available, are drivers driving their own vehicle and can reach the assignment for driving in the calculated required amount of time to do so. In this fashion, software operating in electronic memory engaged to the networked computer or server of the system provider, can continuously ascertain the geographic location and availability of all drivers who are registered to driver for the system, whether they are at home or are located near an assignment and can walk there substantially in a calculated amount of time so as to default first to pedestrian licensed drivers. Should such not be determined to be available, first assigned drivers who are driving or located at a venue where they can drive to reach the assigned location substantially in the determined or required amount of time.

Alternatively but not as preferred, the system can contract with ride sharing providers who have licensed drivers having vehicles available, such as UBER or LYFT or a local taxi company, or similar driver providers, who have locatable drivers. Such will allow the system herein to thereby provide drivers to the system herein. While not as preferred as using proximate pedestrian licensed drivers, where such are not available, the ride sharing drivers can be assigned to both drive the user vehicle from the starting location to the destination location, and to arrive at the destination location at substantially the arrival time calculated, and pickup and relocate the first assigned driver back to the starting point of the vehicle after arrival at the destination point. In this fashion implementation could move rapidly in areas where such ride sharing companies already are operating and where pedestrian licensed drivers may be too distant to reach the starting point such as rural areas and small towns.

Still further, in a manner to increase usage and decrease impaired driving, the system herein would co-brand and advertise with organizations, such as MADD (Mothers Against Drunk Driving), whereby MADD would advertise and encourage vehicle owners and venue operators to use the service. In this mode of the system, a percentage of revenues from each use would be donated by the system operator to MADD or another organization to aid in their operations to prevent impaired driving. The organization may provide telephone numbers to call for the service through the organization, to encourage users who may not have smart phones.

Finally, while directed to a system where a vehicle owner or authorized user would request a driver to drive their vehicle when they are impaired to do so, it is anticipated the system could also be employed by vehicle owners or users who wish to go to or stay at a particular location, but desire their vehicle to be relocated to a destination location without them. For example, vehicle owners could drive to a lot near an airport, and have their vehicle returned by the first assigned driver to their home or office or other destination location while they travel. The first assigned driver would be picked up by the second assigned driver in the noted fashion above and transported back to the starting point.

With respect to the above description, before explaining at least one preferred embodiment of the herein disclosed software and computer enabled method for providing drivers to relocate user vehicles in detail, it is to be understood that the invention is not limited in its application to the details of construction and to the arrangement of the steps in the following description or illustrated in the drawings. The invention herein described is capable of other embodiments and of being practiced and carried out in various ways which will become obvious to those skilled in the art on reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other electronic and software-enabled driver provision systems and methods and systems for carrying out the several purposes of the present disclosed system. It is important, therefore, that the claims be regarded as including such equivalent construction and methodology insofar as they do not depart from the spirit and scope of the present invention.

### BRIEF DESCRIPTION OF DRAWING FIGURES

FIG. 1 graphically depicts the basic steps or method of the system herein for providing assigned licensed drivers to drive vehicles, from a determined starting location to a user-designated destination location and to concurrently ascertain and provide a secondary driver to arrive at the destination location, and thereafter relocate the first driver back to the starting location.

It should be noted the steps in the system may be reordered and that other aspects of the present invention shall be more readily understood when considered in conjunction with the accompanying drawings and the following detailed description, neither of which should be considered limiting.

### DETAILED DESCRIPTION OF THE PREFERRED EMBODIMENTS OF THE INVENTION

In this description, any directional prepositions if employed, such as up, upwardly, down, downwardly, front, back, top, upper, bottom, lower, left, right and other such terms refer to the device or depictions as such may be oriented are describing such as it appears in the drawings and are used for convenience only. Such terms of direction and location are not intended to be limiting or to imply that the device or method herein has to be used or positioned with graphics in any particular orientation.

Further, computer and network terms such as network, electronic memory, database, browser, media, digital files, graphic interface, videos and other terms are for descriptive purposes only, and should not be considered limiting, due to the wide variance in the art as to such terms depending on which practitioner is employing them. The system herein should be considered to include any and all manner of computers, servers, electronic memory, software, firmware, operating systems, executable programs, files and file formats, databases, computer languages and the like, as would occur to one skilled in the art in any manner as they would be described.

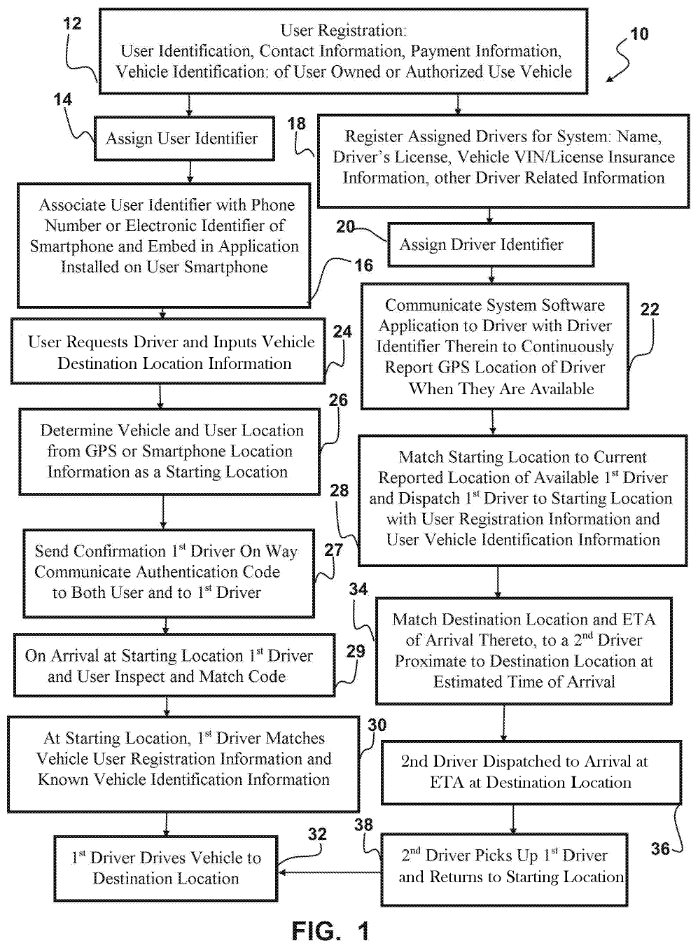

Now referring to drawings in FIG. 1 there is depicted a graphical depiction of the operation of the system 10 herein which in all modes is employed to provide drivers for a vehicle to be driven for a user. In doing so the system employs computer executable code running in electronic memory in communication with a network-connected server or computer of the service provider. The computer executable code or software is configured to the individual tasks required to perform the individual steps in the method herein. The server or computer of the system provider will communicate over a network such as the internet, to computers, pads, and smart phones or other computing devices of users and first and secondary drivers for the system.

As shown, in all modes of the system 10, a vehicle is a requirement since it is the vehicle itself which is to be relocated from a starting location to a designated destination location. While not shown, vehicles such as cars and light trucks are well known. The owner or authorized user of the vehicle to be driven, may or may not accompany it to the destination location.

In a registration step 12 users who own or are authorized drivers of vehicles may be registered to the system 10. Graphic interfaces can be communicated and displayed on the computer device of the user, for the user to input user registration information such as identification, driver's license number, contact information, and payment information for payments for service.

The system 10 may also require the user in the registration step 12, to input vehicle identification information. The vehicle identification information may include the VIN number and/or license plate and the vehicle insurance information. If this information is input by a user in the registration step 12, it will also be provided to the first assigned driver who, in a matching step on arrival at the starting location, will match the vehicle identification information to that of the vehicle to be driven. Such is accomplished by the arriving first driver inspecting the user driver's license or identification and matching the vehicle identification information such as VIN number and/or license number affixed to the vehicle, (such as on the dashboard viewable through the windshield) upon arrival at the starting location.

Upon completion of registration, each user is preferably assigned a user identifier 14 and their registration information including vehicle identification information is saved to electronic memory of the system provider in a database of users and associated with a respective user identifier.

In a next step, a software application having computer executable code which will operate to communicate from the user computing device to the system provider 16 is communicated to the computing device of the user. The software application preferably has the user identifier and their electronic device phone number, Mac ID or other identifier, which is electronically transmitted during use, embedded in the software application. However, the user may also communicate with the system provider by logging into a webpage of the system provider in the event a portable computing device of the user is unavailable.

Alternatively, the application can also have graphic interface windows which display on the user's computer device such as a smartphone, which allow input of the user identifier upon use. In this fashion, the software provided to communicate with the system provider will automatically identify the user or their user identifier and allow the system provider to lookup the information saved in the registration step 12 which is associated with the user identifier.

In another step, the system provider will register vehicle drivers 18 for the system. In doing so, the system provider may also provide the drivers one or more graphic interfaces which display on the screen of their portable computing devices, allowing input of driver information such as drivers license, insurance, name, and other required information.

Thereafter, each driver is preferably assigned a respective driver identifier 20. This driver identifier 20 correlates to the specific human driver and is associated with the information from registration 18 and is stored in electronic memory in a database of vehicle drivers available for the system provider.

Once so registered, drivers may be communicated driver software 22 which operates to run on their portable computing device such as a smartphone. In operation, the driver software will automatically communicate with the server of the system provider over a network such as a cellular network and, when activated to do so, continuously provide the availability of each vehicle driver for an assignment. Additionally, the computer executable code can operate to the task to automatically communicate the geographic location of each available vehicle driver, using GPS and cellular triangulation and other means of determining a current vehicle driver location. In this fashion the availability of each respective driver and their current location when available, is communicated to the server of the system provider and continuously updated.

Further, the system, as noted, preferably may also default to assigning first vehicle drivers for driving assignments at the starting point who live, work, or are otherwise currently located proximate to a vehicle driving assignment. This would work well for drivers assigned to the starting location where they are located nearby and can walk to the starting point, since the first driver assigned does not need a vehicle but simply needs to be able to get to the starting point quickly. Thereafter, they would be returned by the second driver from the destination point. The system preference to use pedestrian first drivers will significantly increase the potential number of first drivers since they need not have a vehicle, but would simply need to be determined proximate to a driving assignment, and have a valid license and insurance.

As noted, in some cases, such as rural locations, the first drivers and/or secondary drivers can also be provided by a third party already having vehicle drivers available. Such providers for example include UBER or LYFT. Such is enabled by the provision of driver availability and location from software provided by those third parties or through a connection with the server of those third parties providing driver location and availably information.

Using the provided software running on their computing device, such as a smartphone, the users can request a driver 24 and can concurrently input a destination location to which they want their vehicle driven using a graphic interface or other input for such during actuation of the user request of the driver 24. In this step the computing device on the user computer will automatically communicate the starting location using the GPS or other system on the user computing device. If such is not available, then the user will input the starting point.

Once a driver is requested in a next step, the starting location of the user requesting the vehicle driver, which is either communicated from the computing device of the user to the system provider 26 or input, is established as a starting location. If not input by the user by requirement, the location is determined using the GPS or other location determining ability of the smartphone, tablet, or computing device or may be input in a field of a graphic interface of the software on the user computing device.

Upon determination of the starting location of a vehicle from the location information transmitted from the user device to the system provider server over a network such as a cellular network, a first driver is matched 28 to drive the vehicle of a user employing software operating to the task of matching the vehicle starting location with a current terrestrial location of an available vehicle driver. Preferably the system defaults to pick vehicle drivers who can walk to the vehicle starting location in time period of between five to fifteen minutes. If a pedestrian driver is not available, the system will ascertain a vehicle driver who is driving nearby to assign as the first driver. The first driver is dispatched to the vehicle starting location and would either walk or drive to the starting point location to thereafter drive the vehicle of the user to the destination location.

Optionally but preferred, the system will communicate the same authentication code, to each of the assigned first driver, and the user 27. On arrival at the starting location, both the first driver and user will match their respective authentication code 29.

On arrival at the starting point location, the first driver may match identification documents in possession of the user to ascertain they are the user with the determined user identifier 14. Additionally the assigned first driver will also match the vehicle identification information of the vehicle to that stored in the system from the vehicle identification provided during user registration 12.

Upon determination of correct user identifier 14 and a match to the vehicle identification information, the first driver will begin to drive the vehicle along roads to the destination location 32. The first driver may communicate a signal to the system, a departure time upon which the driving has begun, or a departure time in the near future when it will begin.

Concurrently, with the first driver beginning the drive to the destination location 32, computer executable code running in computer memory of the computer of the system provider will operate to the task of calculating an estimated time or arrival of the vehicle leaving the starting location and driving to the destination location. The computer executable code will then discern the current locations of all drivers with vehicles who are registered with the system. Using the secondary vehicle driver's current locations, the system will then match and ascertain 34 an available second driver, who is proximate or will be proximate to the destination location, at the estimated time of arrival of the vehicle driven by the first driver.

In a next step 36, the ascertained second driver, who is available and is or will be proximate to the destination location at the estimated time of arrival, is despatched to the destination location by the system using computer executable code operating to that task.

Thereafter, in a final step 38, the second driver arrives at substantially the same time at the destination location, as calculated by the system when the second driver was chosen and notified. Upon arrival the second driver picks up the first driver in the vehicle driven by the second driver, and will transport the first driver back to the starting location.

It should be noted that the system herein may also include a step for determining the sobriety and ability to drive of the assigned first and second drivers if need be. Such could be ascertained by having the potential drivers input a breath test through their portable computing device using a breath testing device which would plug into the portable computing device and determine the first or the second driver is indeed legally capable of driving.

In this fashion, users with vehicles can have the vehicle driven from a starting point and left at a destination location by a first driver and the user may ride along or go elsewhere. Further, on arrival the first driver driving the vehicle from the starting point to the destination location, is transported by the second driver back to the starting location where the first driver may continue to be available as a driver for the system provider.

While all of the fundamental characteristics and features of the driver providing system for user vehicles herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful system, various substitutions, modifications, and variations may occur to and be made by those skilled in the art without departing from the spirit or scope of the invention. Consequently, all such modifications and variations and substitutions, as would occur to those skilled in the art are considered included within the scope of the invention as defined by the following claims.

What is claimed is:

1. A computer-implemented method of relocating vehicles for requesting owners, comprising:
running computer executable code by one or more computers which are connected to a computer network, for the steps of:
registering users and associating each user with at least one user vehicle said user is authorized to drive, and saving their information in a database of registered users;
registering a first group of licensed drivers having a driver vehicle for driving to a said driving assignment;
receiving a request from a respective registered user to drive their respective user vehicle from a starting location, to a destination location;
choosing a first assigned driver, from said first group of licensed drivers, and dispatching said first assigned driver to said starting location;
calculating a driving time for said user vehicle from said starting location to said destination location to determine an arrival time;
determining real time locations of said licensed drivers in said first group, and choosing a secondary driver from said first group of licensed drivers who determined to be in a respective real time location calculated to allow them to drive their respective driver vehicle and arrive at said destination location, substantially at said arrival time; and
dispatching said secondary driver to said destination location with instructions to transport said first assigned driver in said driver vehicle back to said starting location.

2. A computer-implemented method of claim 1, comprising the additional step of:
registering a second group of licensed drivers as walking drivers, for walking to a driving assignment;
prior to choosing said first assigned driver, from said first group of licensed drivers, determining respective real time locations of said walking drivers in said second group of licensed drivers; and
choosing a walking driver as said first assigned driver, from said second group of licensed drivers, instead of said first group of licensed drivers, if a walking time from said real time location of said walking driver to said starting location, is calculated to be less than fifteen minutes.

3. A computer-implemented method of claim 1, comprising the additional step of:
communicating an authorization code to said first assigned driver and to said registered user for a matching thereof by said first assigned driver and said registered user, upon arrival of said first assigned driver at said starting location.

4. A computer-implemented method of claim 2, comprising the additional step of:
communicating an authorization code to said first assigned driver and to said registered user for a matching thereof by said first assigned driver and said registered user, upon arrival of said first assigned driver at said starting location.
